(19) United States
(12) Patent Application Publication
(10) Pub. No.: US 2014/0250115 A1
(43) Pub. Date: Sep. 4, 2014

(54) Prototype-Based Re-Ranking of Search Results

(71) Applicant: Linjun Yang, Beijing (CN)

(72) Inventor: Linjun Yang, Beijing (CN)

(73) Assignee: MICROSOFT CORPORATION, Redmond, WA (US)

(21) Appl. No.: 13/395,420

(22) PCT Filed: Nov. 21, 2011
(86) PCT No.: PCT/CN2011/082507

§ 371 Date: Mar. 9, 2012

(51) Int. Cl. G06F 17/30

(52) U.S. Cl. CPC G06F 17/3053; G06F 17/30244
USPC 707/728

(57) ABSTRACT

A prototype-based re-ranking method may re-rank search results to provide a re-ranked set of search results. In response to receiving one or more queries, a set of search results may be generated whereby each of the search results may be associated with a rank position. Based at least in part on the search results, one or more prototypes may be generated that visually represent the one or more queries or the search results. The one or more prototypes may be used to construct one or more meta re-rankers that may generate re-ranking scores for the search results. The re-ranking scores may be aggregated to produce a final relevance score for each search result included in the set of search results. Based at least in part on the relevance score of each search result and/or a learned re-ranking model, a set of re-ranked search results may be provided.

### CROSS REFERENCE TO RELATED APPLICATIONS

This application is a 35 U.S.C. 371 National Stage application of International Application No. PCT/CN2011/082507, filed Nov. 21, 2011, the entire contents of which are incorporated herein by reference.

### BACKGROUND

It has become commonplace for users to search for various types of information utilizing a network, such as the Internet. For example, utilizing a computing device, users may submit queries for such information to a web-based search engine and may subsequently receive search results responsive to the queries. In particular, provided that a user is searching for one or more images, a web-based search engine may retrieve and rank images based on text associated with the web pages in which the images are found (e.g., title, actual content, metadata, etc.). However, the images returned to the user may be unsatisfactory to the user and/or may not be relevant and/or responsive to the corresponding query. This may be due to a mismatch or a lack of relevance between the returned images and the text corresponding to the web pages that were identified by the search engine. Therefore, since the precision of the search results may be limited as a result of such mismatches, the user may often receive search results that are not relevant, which may cause a poor user experience.

### SUMMARY

Described herein are systems and processes for re-ranking a set of search results based at least in part on a re-ranking model. In various embodiments, one or more queries may be received from a user. In response, a set of search results may be generated, in which each of the search results may be associated with a rank position within the set of search results. Based at least in part on the search results, one or more prototypes may be generated that visually represent the one or more queries and/or the search results. The one or more prototypes may be used to construct one or more meta re-rankers that may generate re-ranking scores for each of the search results. The re-ranking scores may then be aggregated to produce a final relevance score for each search result included in the set of search results. The re-ranking model may also be learned based at least in part on the search results. Based at least in part on the relevance score of each search result and/or the learned re-ranking model, a set of re-ranked search results may be provided.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example system including a user, a computing device, a network, and a content server. In this system, a set of search results may be re-ranked and output to the user.

FIG. 2 is a diagram showing an example system for generating a set of re-ranked images in response to receiving a query.

FIG. 3 is a diagram showing a system for constructing one or more prototypes or meta re-rankers based at least in part on images determined to be relevant to a query.

FIG. 4 is a diagram showing a system for constructing one or more prototypes or meta re-rankers by iteratively associating one or more images with the meta re-rankers.

FIG. 5 is a flow diagram showing an example process of re-ranking a set of search results based at least in part on a re-ranking model.

### DETAILED DESCRIPTION

Described herein are systems and/or processes for re-ranking multiple images based at least in part on supervised and/or unsupervised learning. In some embodiments, the systems and processes described herein may learn a re-ranking model that may be utilized to re-rank multiple images that have been returned in response to one or more queries. More particularly, the re-ranking model may be learned in a supervised manner by which at least parts of initial text-based search results are interpreted as being relevant. Further, text-based search results obtained for a limited number of representative queries may be manually labeled with respect to their respective relevance to the representative queries.

With respect to a set of search results that are returned in response to one or more queries, existing re-ranking processes may re-rank the top N images of the set of search results in various manners. However, these processes tend to assume that the top N images are equally relevant with respect to the one or more queries. Moreover, since the text-based search engine that was used to generate the set of search results may not generate search results that are entirely relevant and/or responsive to the one or more queries, the search engine may return images that are not of interest to a user. As a result, the top N images from the set of search results may also not be relevant to the one or more queries. The presence of these irrelevant images may introduce noise into the learning of re-ranking models, which may lead to sub-optimal search results being returned after the images are re-ranked.

In various embodiments, for each query, the images that are determined to be relevant to the queries and that are ranked (at different rank positions) may have different probabilities of being relevant to that query. For instance, an image that is determined to be ranked first with respect to a particular query may have a different likelihood of being relevant to that query than an image that is determined to be ranked lower (e.g., seventh) than the first-ranked image. Therefore, in order to re-rank the images based on their respective relevance to a corresponding query, a prototype-based process may be utilized to re-rank the images based at least in part on supervised and/or unsupervised learning of a learning model and/or based at least in part on the notion that the relevance probability of each image may be correlated to its rank position in the initial search result.

Based at least in part on the images identified in the initial search results, visual prototypes that may visually represent one or more queries may be generated. The visual prototypes may be any type of application, model, and/or schema and may be used to construct one or more meta re-rankers that may produce a re-ranking score for images included in the initial search results. The meta re-rankers may also be any type of application, model, and/or schema that is configured to generate the re-ranking scores. Furthermore, the re-ranking scores from each of the meta re-rankers may be aggregated utilizing a re-ranking model, such as a linear re-ranking model, in order to produce a final relevance score for each image and to define the position of each image in a set of re-ranked search results.

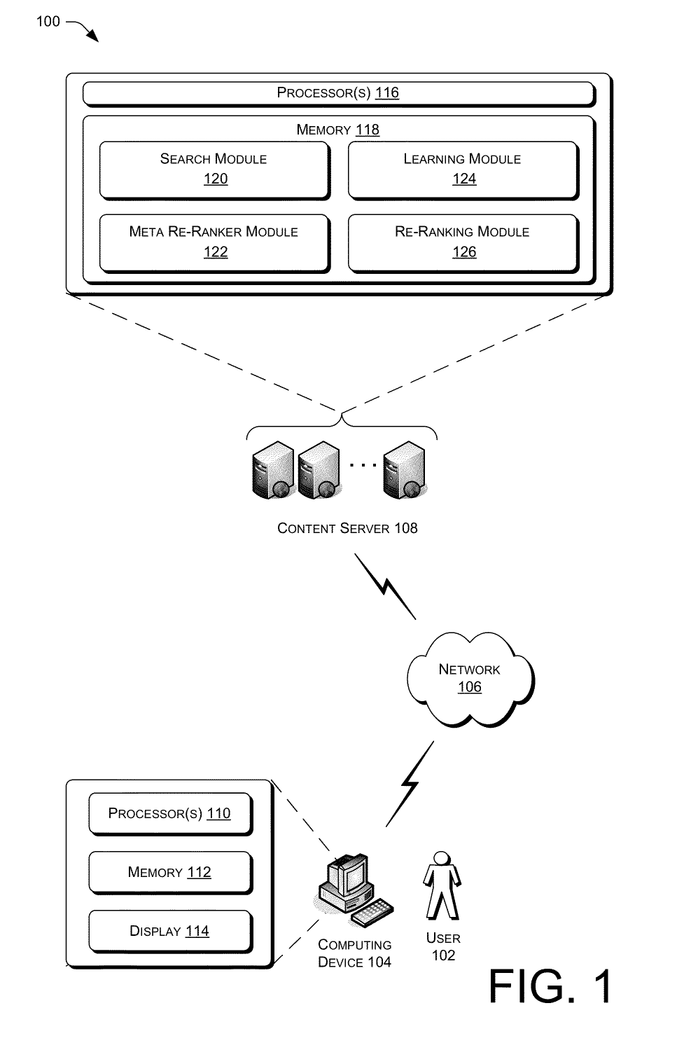

In example embodiments, the re-ranking model may be learned in a supervised manner by which appropriate weights may be assigned to different meta re-rankers. Since the learned model weights may be related to the initial rank position of a corresponding image, and not to the image itself, the re-ranking model may be query-independent and may be applied across multiple different queries. Furthermore, the re-ranking model may be learned in an unsupervised manner. In particular, the relevance of various search results (e.g., images) from representative queries may be manually determined and then utilized to train the re-ranking model. Various examples of providing a set of re-ranked search results in response to one or more queries, in accordance with the embodiments, are described below with reference to FIGS. 1-5.

FIG. 1 illustrates a system 100 for re-ranking search results in response to one or more queries based at least in part on a learned re-ranking model. More particularly, the system 100 may include a user 102, a computing device 104, a network 106, and a content server 108. In various embodiments, the computing device 104 may include one or more processor(s) 110, memory 112, and a display 114. Moreover, the content server 108 may include one or more processor(s) 116 and memory 118, which may include a search module 120, a meta re-ranker module 122, a learning module 124, and a re-ranking module 126.

In various embodiments, the user 102 may utilize the computing device 104 to search for, access, and/or review various types of information (e.g., text, images, etc.). More particularly, the user 102 may use the computing device 104 to submit one or more queries in order to receive information responsive to those queries. In response, a search engine, or other mechanisms, may return search results that may have varying degrees of relevance and/or responsiveness to the queries that were previously submitted. In example embodiments, the search results that are returned to the user 102 may be ranked in the order of their respective relevance to the queries. The user 102 may access and/or view the search results via the display 114 of the computing device 104. Various components of the computing device 104 will be described in additional detail as set forth below.

In some embodiments, the network 106 may be any type of network known in the art, such as the Internet, and may include multiple of the same or different networks. Moreover, the computing device 104 may be communicatively coupled to the network 106 in any manner, such as by a wired and/or wireless connection. Additionally, the network 106 may communicatively couple the computing device 104 to the content server 108 such that the user 102 may utilize the computing device 104 to submit queries for information and the content server 108 may return search results to the computing device 104 that are responsive and/or relevant to the queries.

Further, the content server 108 may be any type of computing device or server known in the art, such as a web server. The content server 108 may store, and/or may have access to, various types of information that may be provided to the computing device 104. In various embodiments, this information may include media content (e.g., video files, audio files, etc.), text data, images, web documents, and/or any other type of content known in the art. Moreover, and as shown in FIG. 1, the content server 108 may include the processor(s) 116 and the memory 118, which may include the search module 120, the meta re-ranker module 122, the learning module 124, and the re-ranking module 126, which will be described in additional detail below.

The techniques and mechanisms described herein may be implemented by multiple instances of the computing device 104 and/or the content server 108, as well as by any other computing device, system, and/or environment. The computing device 104 and the content server 108 shown in FIG. 1 are only examples of a computing device and server, respectively and are not intended to suggest any limitation as to the scope of use or functionality of any computing device or server utilized to perform the processes and/or procedures described herein.

With respect to the computing device 104, the processor(s) 110 may execute one or more modules and/or processes to cause the computing device 102 to perform a variety of functions. In some embodiments, the processor(s) 110 are a central processing unit (CPU), a graphics processing unit (GPU), both CPU and GPU, or other processing units or components known in the art. Additionally, each of the processor(s) 110 may possess its own local memory, which also may store program modules, program data, and/or one or more operating systems. The computing device 104 may also possess some type of component, such as a communication interface, that may allow the computing device 104 to communicate and/or interface with the network 106 and/or one or more devices, such as the content server 108.

Depending on the exact configuration and type of the computing device 104, the memory 114 may be volatile (such as RAM), non-volatile (such as ROM, flash memory, miniature hard drive, memory card, or the like) or some combination thereof. The memory 114 may include an operating system, one or more program modules, and may include program data.

The computing device 104 may have additional features and/or functionality. For example, the computing device 104 may also include additional data storage devices (removable and/or non-removable) such as, for example, magnetic disks, optical disks, or tape. Such additional storage may include removable storage and/or non-removable storage.

The computing device 104 may also have input device(s) such as a keyboard, a mouse, a pen, a voice input device, a touch input device, etc. Output device(s), such as the display 114, speakers, a printer, etc. may also be included. In some embodiments, the user 102 may utilize the foregoing features to interact with the computing device 104, the network 106, and/or the content server 108. For instance, the input device(s) of the computing device 104 may be used to submit one or more queries and the display 114 of the computing device 104 may be utilized to access and/or view search results that are responsive and/or relevant to the previously submitted queries.

It is appreciated that the illustrated computing device 104 is only one example of a suitable device and is not intended to suggest any limitation as to the scope of use or functionality of the various embodiments described. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, and/or distributed computing environments that include any of the above systems or devices. In addition, any or all of the above devices may be implemented at least in part by implementations using field programmable gate arrays (“FPGAs”) and application specific integrated circuits (“ASICs”), and/or the like.

In other embodiments, and as stated above, the content server 108 may be any type of server that is configured to provide search results to the user 102. More particularly, the content server 108 may be configured to receive a query, generate search results responsive to the query, learn a re-ranking model, and/or provide a set of re-ranked search results to the user 102 based at least in part on the re-ranking model. As mentioned previously, the content server 108 may include one or more processor(s) 116 and memory 118, which may be similar or different to the processor(s) 110 and the memory 112, respectively, of the computing device 104.

In various embodiments, computer-readable media may include, at least, two types of computer-readable media, namely computer storage media and communication media. Computer storage media may include volatile and non-volatile, removable, and non-removable media implemented in any method or technology for storage of information, such as computer readable instructions, data structures, program modules, or other data. The memory 114 and 118, the removable storage and the non-removable storage are all examples of computer storage media. Computer storage media includes, but is not limited to, random-access memory (RAM), read-only memory (ROM), electrically erasable programmable read-only memory (EEPROM), flash memory or other memory technology, compact disc read-only memory (CD-ROM), digital versatile disks (DVD), or other optical storage, magnetic cassettes, magnetic tape, magnetic disk storage or other magnetic storage devices, or any other non-transmission medium that can be used to store the desired information and which can be accessed by the computing device 104 and/or the content server 108. Any such computer storage media may be part of the computing device 104. Moreover, the computer-readable media may include computer-executable instructions that, when executed by the processor(s) 110 and 116, perform various functions and/or operations described herein.

In contrast, communication media may embody computer-readable instructions, data structures, program modules, or other data in a modulated data signal, such as a carrier wave, or other transmission mechanism. As defined herein, computer storage media does not include communication media. In various embodiments, memory 112 and 118 may be examples of computer-readable media.

In some embodiments, the memory 118 of the content server 108 may include the search module 120. The search module 120 may receive one or more queries from the user 102 of the computing device 104. The one or more queries may relate to a request for a particular type of information (e.g., data, images, etc.). In response to the one or more queries, the search module 120 of the content server 108 may search for information that is responsive and/or relevant to the one or more queries. To generate a set of search results, the search module 120 may determine whether certain information is relevant to the one or more queries. This set of search results may then be ranked by the search module 120 based at least in part on their respective relevance to the one or more queries and, optionally, may be provided to the user 102 via the computing device 104.

In other embodiments, the meta re-ranker module 122 may, based at least in part on images included within the set of search results, generate visual prototypes that may visually represent one or more of the queries and/or the set of search results. Further, the meta re-ranker module 122 may use the visual prototypes to construct one or more meta re-rankers that are configured to produce a re-ranking score for any image included in the initial set of results.

Furthermore, the learning module 124 of the content server 108 may utilize search results and/or the re-ranking scores to learn a re-ranking model. In some embodiments, the re-ranking model may be learned in an unsupervised and/or a supervised manner. For the purposes of this discussion, whether the re-ranking of search results is classified as unsupervised or supervised may depend upon whether the re-ranking model has been learned based on a manual process (e.g., supervised) or an automated process (e.g., unsupervised). More particularly, unsupervised learning may not rely on human and/or manual labeling of relevant data (e.g., images). Instead, unsupervised learning may be based at least in part on prior assumptions regarding how to employ information contained in the underlying set of search results for re-ranking the set of search results. For example, unsupervised learning processes may include utilizing search results within a set of search results that are determined to be relevant to a query to learn a re-ranking model. Moreover, the rank position associated with each search result may also be considered.

On the other hand, and in other embodiments, supervised learning may include human involvement and/or a manual process being used to re-rank the set of search results. More particularly, supervised learning may include manually labeling search results within a set of search results as being relevant to a query and then utilizing the relevant search results to learn a re-ranking model. Subsequently, the learned re-ranking model may be used to re-rank the set of search results and ultimately provide those re-ranked search results to the user 102.

Moreover, the re-ranking module 126 of the content server may utilize the re-ranking model and the re-ranking scores generated by the meta re-ranker module 122 to re-rank the set of search results. As a result, the re-ranked images may reflect a hierarchical order of relevance with respect to the previously submitted queries, meaning that the first ranked image is determined to be the most relevant, the second ranked image is determined to be the second most relevant image, and so on. The set of re-ranked images may then be provided to, and be accessed by, the user 102 at the computing device 104 via the network 106. In some embodiments, the set of re-ranked images may reflect a set of information (e.g., images) that is most relevant and/or responsive to the queries submitted by the user 102. The user 102 may access this information in order to identify information that is likely to be of interest to the user 102. In some embodiments, the relevance and/or responsiveness of the re-ranked images may be based at least in part on scores or other metrics that are assigned to each re-ranked image.

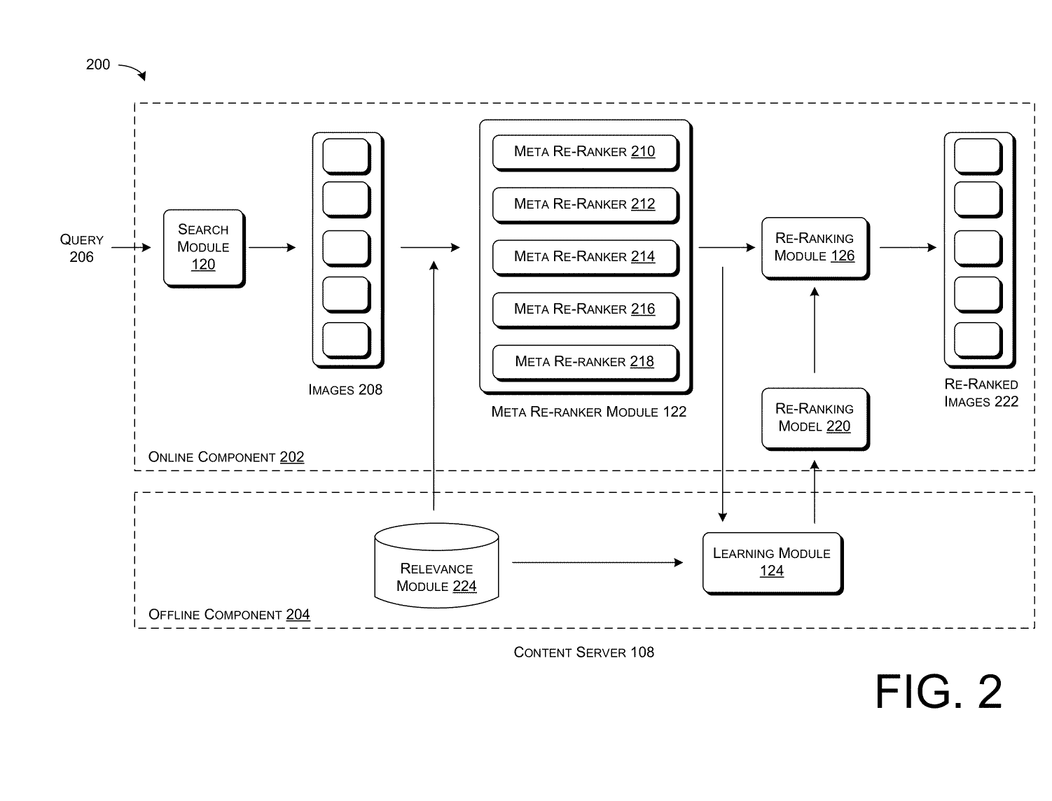

The search module 120, the meta-ranker module 122, the learning module 124, and the re-ranking module 126 will be described in additional detail with respect to FIGS. 2-5.

FIG. 2 illustrates a system 200 that provides a set of re-ranked data in response to receiving one or more queries based at least in part on supervised and/or unsupervised learning. In some embodiments, the system 200 may include the content server 108, as discussed with respect to FIG. 1. The content server 108 may include an online component 202 and an offline component 204. In various embodiments, the online component 202 may receive a query 206 and may include the search module 120, one or more images 208, the meta re-ranker module 122, the re-ranking module 126, a re-ranking model 220, and a set of re-ranked images 222. Further, the offline module 204 of the content server 108 may include a relevance module 224 and the learning module 124. The content server 108 and more particularly, the online component 202, may receive the query 206 from the user 102 of the computing device 104. In some embodiments, the query 206 may represent multiple queries submitted by the user 102, either simultaneously or at different times.

In various embodiments, in response to receiving one or more queries 206, the content server 108 may identify a set of search results (e.g., images) that are believed to be relevant and/or responsive to the one or more queries 206. Although the data within the set of search results may be ranked, the ranking of each search result may not correspond to its actual relevance to the one or more queries. As a result, the content server 108 may learn the re-ranking model 220 and utilize the re-ranking model 220 to re-rank the search results within the set of search results. Accordingly, the set of re-ranked search results may be ranked based at least in part on their respective relevance and/or responsiveness to the previously submitted queries 206. Once provided to the computing device 104, the user 102 may receive relevant data (e.g., images) that is believed to be relevant to the user's 102 queries 206.

More particularly, the online component 202 of the content server 108 may receive the query 206 from a computing device 104 via the network 106. For example, a user 102 that is operating the computing device 104 may submit the query 206 requesting a particular type of information, such as media content, images, textual data, etc. In response, the user 102 may expect to receive information that is responsive and/or relevant to the query 206. Upon receiving the query 206, the search module 120 may search for such information and make a determination of whether various information is relevant and/or responsive to the query 206. In some embodiments, the search module 120 may be any type of search engine and/or be communicatively coupled thereto.

Based at least in part on the query 206, the search module 120 may return a set of search results. In these embodiments, the set of search results may include a set of images 208 (e.g., five images). However, the search results may include any type of information and are not limited to a particular number. In various embodiments, the images 208 returned by the search module 120 may be determined to be relevant and/or responsive to the query 206, such as by utilizing a search engine and ranking the images 208. In these embodiments, the relevance module 224 of the offline component 204 may be utilized to determine the relevance of the images 208 returned by the search module 120. The relevance module 224 may include a variety of data/information and/or prior query-search result pairs that may be utilized to determine whether a particular image 208 is relevant to the query 206. The query-search result pairs may have been formed as a result of previous queries 206 submitted by the user 102 and/or other users.

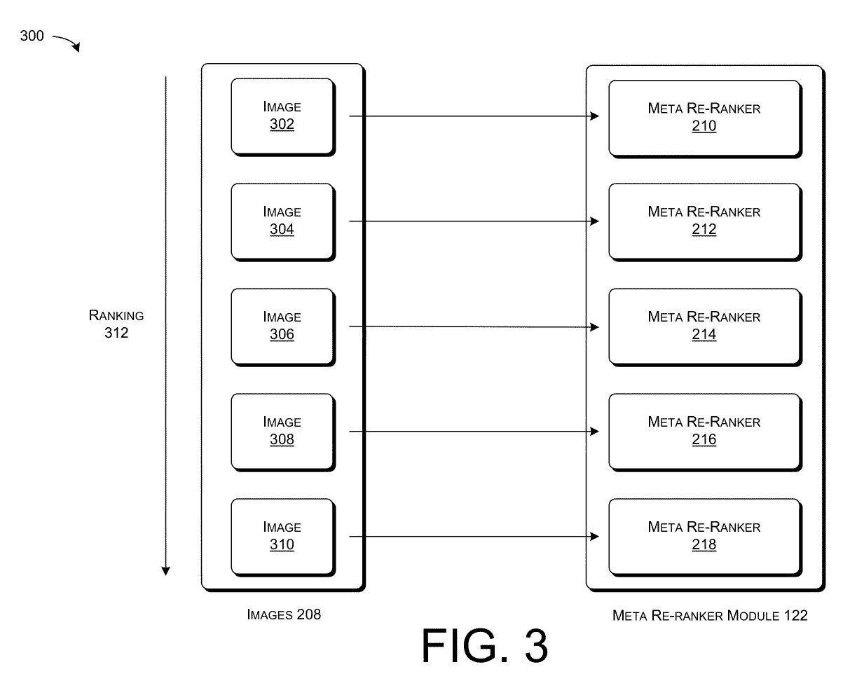

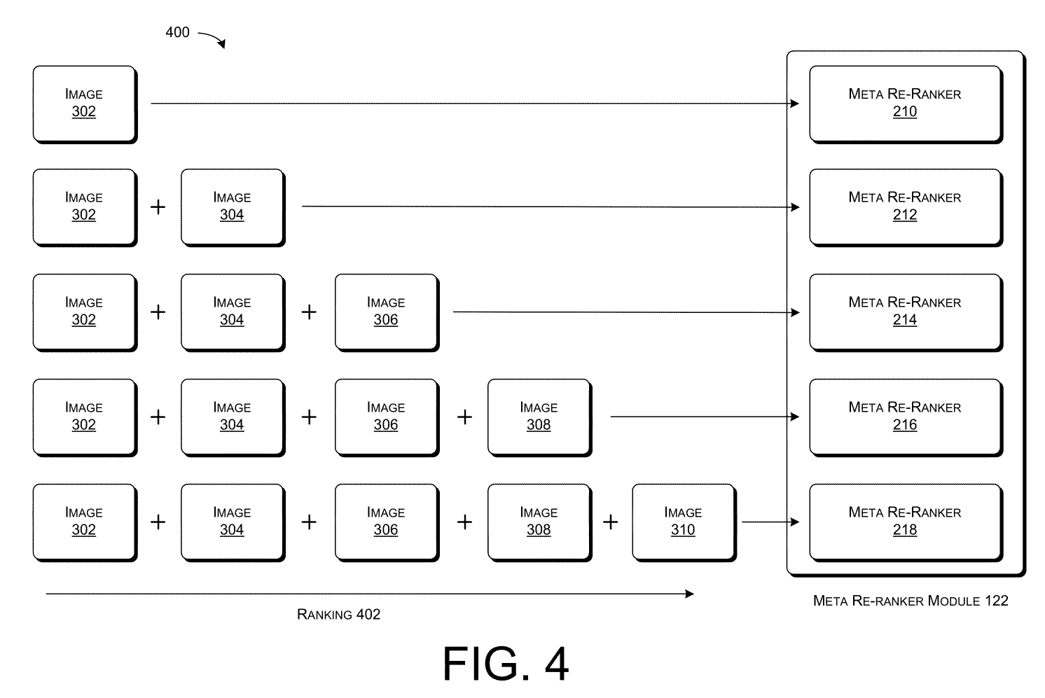

In other embodiments, based on the images 208 included in the initial search results, any number of prototypes, possibly including visual prototypes, that may represent the query 206 and/or the images 208 may be generated. Moreover, for each of the prototypes that are generated, the meta re-ranker module 122 may construct a meta re-ranker, such as meta re-rankers 210-218. The construction of the meta re-rankers 210-218 is explained in additional detail with respect to FIGS. 3 and 4.

In various embodiments, for each of the top N images 208 in the initial search results (where N may be any number), the meta re-ranker module 122 may obtain or generate a dimensional score vector. In these embodiments, the dimensional score vector may include the scores for the meta re-rankers 210-218 when applied to that particular image 208. Once the dimensional score vector is determined for each of the top N images 208, the dimensional score vectors may be used as input to the re-ranking module 126. As shown below, the re-ranking model 220 may have been trained or learned by the offline component 204 and, therefore, may be configured to generate re-ranking scores for each of the images 208. As a result, the re-ranking module 126 may re-rank the images 208 in order to generate a set of re-ranked images 222. In various embodiments, the re-ranked images 222 may be ordered so that the most relevant and/or responsive images are presented to the user 102. Moreover, the re-ranked images 222 may be presented in a hierarchical order with the most relevant images 208 being presented first.

In addition, the offline component 204 of the content server 108 may learn the re-ranking model 220 so that the re-ranking module 126 may facilitate re-ranking the images 208. In certain embodiments, the learning module 124 of the offline component 204 may learn the re-ranking model 220 based at least in part on manually labeled training data. Since the learning module 124 may be utilized to re-rank the search results (e.g., images 208), training data may be constructed from the search results. For example, in various embodiments the relevance module 224 may maintain a query log that identifies queries 206 that have been submitted to the content server 108 and information that has been determined to be relevant and/or responsive to those queries 206. In order to learn the re-ranking model 224, the learning module 124 may obtain and/or select one or more representative queries 206 from the relevance module 224. The learning module 124 may then utilize these representative queries 206 to retrieve the top N images from the search module 120 and download these images for subsequent processing. As stated above, any number of images may be retrieved by the learning module 124.

Accordingly, the learning module 124 may associate particular images 208 with specific queries 206 (e.g., query-image pairs). Moreover, for reach query-image pair, the relevance of each image 208 to its corresponding query 206 may be manually labeled. In some embodiments, this may be performed by an individual operating some type of device or by an automated or semi-automated process. Once the query-image pairs have been relevance labeled, the learning module 124 may collect this training data and then compute the score vector from the meta re-rankers 210-218, as discussed above with respect to the online component 202, for each image 208 and corresponding query 206. Subsequently, the learning module 124 may utilize the score vectors to learn the re-ranking model 220, which may then be stored in the memory 118 and utilized by the online component 202 for re-ranking the images 208 that correspond to the user-submitted queries 206.

In various embodiments, the re-ranking model 220 may be learned by estimating the weights of the combined scores (e.g., score vectors) that are generated by the meta re-ranker module 122, and specifically by the different meta re-rankers 210-218. More particularly, the re-ranking model 220 and/or the re-ranking module 126 may utilize a learning-to-rank process, by which the score vectors output by the meta re-ranker module 122 may be utilized as a ranking feature with respect to a particular image 208. In some embodiments, the re-ranking model 220 may be learned by the learning module 124 by decomposing a ranking into a set of pair-wise preferences and by utilizing one or more algorithms, such as Equation 1, set forth below:

$$min \frac{1}{2} {W}^{T} W + C {\sum }^{ } {ξ}_{jk}^{i} \\ s . t . \\ ∀ {q}_{i} , {I}_{j} ≻ {I}_{k} \text{:} {W}^{T} ( M ( {I}_{j} ) - M ( {I}_{k} ) ) \geq 1 - {ξ}_{jk}^{i} \\ ∀ i , j , k \text{:} {ξ}_{jk}^{i} \geq 0 \qquad ( 1 )$$

In Equation 1, W may refer to a model weight vector, C may be a parameter to trade-off loss and regularization, M(Iⱼ) may refer to the score vector from the meta re-rankers 210-218 for a particular image Iⱼ, and Iⱼ>Iₖ may indicate that Iⱼ is more relevant than Iₖ for a particular query qᵢ. In some embodiments, standard efficient approaches for learning the re-ranking model 220, such as Sequential Minimal Optimization, may be utilized. Furthermore, in other embodiments, a fast algorithm (e.g., a cutting-plane algorithm) may also be adopted to increase the rate of learning the re-ranking model 220.

Since the model weights and/or vector scores may not related to specific images 208, but may instead be related to their respective rank positions in the initial search results, the re-ranking model 220 may be generalized across multiple queries 206 in addition to those queries 206 that were utilized to learn the re-ranking model 220. That is, the learning module 124 may learn the re-ranking model 220 by determining how likely the images 208 at each of the ranked positions in the set of search results are to be relevant and/or responsive to the query 206. As a result, separation of the weights/scores from particular images 208 may allow the re-ranking model 220 to be learned once and then be applied to any arbitrary query 206. That is, upon receiving a new query 206, the content server 108 may be able to re-rank the set of search results (e.g., images 208) associated with that query 206 based at least in part on the rank positions of the images 208 within the set of search results and without having to re-learn the re-ranking model 220.

FIG. 3 illustrates a system 300 for constructing one or more prototypes or a set of meta re-rankers associated with re-ranking a set of search results. In particular, the system 300 may include a set of search results (e.g., the images 208) illustrated in FIG. 2, which also may include images 302-310. That is, the images 208 may have been returned in response to receiving a query (e.g., query 206) and may have been determined to be relevant and/or responsive to the query 206. Moreover, each of the images 302-310 may have an associated ranking 312 and/or rank position, whereby the ranking 312 and/or rank position may be dependent upon the relevance and/or responsiveness of each image 302-310 to a particular query 206. The images 302-310 may be ranked 312 in any order and/or may be ranked in any manner (e.g., hierarchical, etc.). In some embodiments, the arrow representing the ranking 312 may represent the respective relevance of each image 302-310 to a particular query 206 with respect to the other images in the set of images 208. For example, since the arrow is pointing downward, which may represent a higher to lower ranking, image 302 may have been determined to be the most relevant and/or responsive to a particular query 206 whereas image 310 may have been determined to be the least relevant and/or responsive to that query 206.

They system 300 may also include the meta re-ranker module 122, which may include meta re-rankers 210-218, as shown in FIG. 2. As mentioned previously the meta re-rankers 210-218 may be constructed so that, for each of the top N images 208, a dimensional score vector may be generated and provided to the re-ranking module 126 as input. In some embodiments, the dimensional score vector may include the scores generated by the meta re-rankers 210-218 with respect to a particular image 208. Since the re-ranking model 220 may have been previously learned and/or trained, the re-ranking model 220 and/or the re-ranking module 126 may estimate the ranking scores for the set of re-ranked images 222. As illustrated in FIG. 3, images 302-310 correspond to meta re-rankers 210-218, respectively. That is, each image 302-310 may correspond to and/or be associated with a different one of the meta re-rankers 210-218.

In various embodiments, in order to construct the prototypes or the meta re-rankers 210-218, given a prototype Pᵢ and a set of N images {Iⱼ}ⱼ₌₁^{N}, the ranking scores {M(Iⱼ|Pᵢ)}ⱼ₌₁^{N} for these images 208 may be computed based on the prototype Pᵢ. The computed scores may then be used as input for the re-ranking model 220 and/or the re-ranking module 126 to estimate the ranking scores for various images 208. Further, the ranking scores may be used to determine the rank position of each image 208 within the set of re-ranked images 222. In various embodiments, the type of meta-ranker that is constructed may depend upon how the prototypes are generated from the initial set of search results. FIG. 3 may represent constructing the prototypes or the meta re-rankers 210-218 based at least in part on a single-image prototype.

For instance, and in some embodiments, the prototypes or the meta re-rankers 210-218 may be constructed by generating one or more prototypes by selecting the top L images from the initial set of search results, which may be represented by images 302-310, as illustrated in FIG. 3. Provided that the top L set of images is denoted as {Pᵢ^{S}}ᵢ₌₁^{L}, then the meta re-rankers 210-218 may be constructed based at least in part on the visual similarity S(.) between the prototype Pᵢ^{S} and the image Iⱼ to be ranked, as shown in Equation 2:

M^{S}(Iⱼ|Pᵢ^{S})=S(Iⱼ,Pᵢ^{S}). (2)

The score vector may be determined by aggregating the values from Equation 2 for each of the L meta re-rankers and then may be utilized as input for the re-ranking model 220 and/or the re-ranking module 126. Then, the re-ranking model 220 and/or the re-ranking module 126 may be able to compute the definitive ranking score for image Iⱼ, which may be represented by Equation 3:

R^{S}(Iⱼ)=Σᵢ₌₁^{L}wᵢ×S(Iⱼ,Pᵢ^{S}). (3)

With respect to Equation 3, wᵢ may refer to the individual weights from the model weight vector W. Re-ranking the initial set of search results utilizing single-image prototypes may be based at least in part on the assumption that the relevance of a particular image 208 may be correlated to its relative rank position within the initial set of search results. In some embodiments, re-ranking the set of search results in the foregoing manner may allow the content server 108 to be more robust with respect to impreciseness and/or unreliability of the set of search results that are returned in response to a particular query 206. This may be due to the relevance-rank correlation being actually reflected in the objective of the search module 120. In addition, and as mentioned previously, the learning module 220 may learn the re-ranking module 126 in a query-independent manner such that the re-ranking module 126 may re-rank sets of search results regardless of the query 206 that is submitted to the content server 108. For example, since the learning module 124 is configured to leverage relevance-labeled data from a limited number of representative queries 206 to learn and/or train the re-ranking model 220, the re-ranking model 220 may facilitate in enabling the re-ranking module 126 to re-rank sets of search results across a broad range of queries 206. As a result, introducing supervision into the learning process may not jeopardize scalability of the content server 108.

FIG. 4 illustrates a system 400 for constructing one or more prototypes or a set of meta re-rankers associated with re-ranking a set of search results. More particularly, the system 400 may include multiple images 302-310 from a set of search results (e.g., images 208). That is, the images 302-310 may be selected since they have been determined to be more relevant and/or responsive to a particular query 206. Moreover, each of the images 302-310 may have an associated ranking 402 and/or rank position, whereby the ranking 402 and/or the rank position may be dependent upon the relevance and/or responsiveness of each image 302-310 to a particular query 206. The images 302-310 may be ranked 402 in any order and/or may be ranked in any manner (e.g., hierarchical, etc.). In some embodiments, the arrow representing the ranking 402 may represent the respective relevance of each image 302-310 to a particular query 206 with respect to the other images in the set of images 208. For example, since the arrow is pointing from left to right, which may represent a higher to lower ranking, image 302 may have been determined to be the most relevant and/or responsive to a particular query 206 whereas image 310 may have been determined to be the least relevant and/or responsive to that query 206.

They system 400 may also include the meta re-ranker module 122, which may include meta re-rankers 210-218, as shown in FIG. 2. As mentioned previously, the meta re-rankers 210-218 may be constructed so that, for each of the top N images 208, a dimensional score vector may be generated and provided to the re-ranking module 126 as input. In some embodiments, the dimensional score vector may include the scores generated by the meta re-rankers 210-218 with respect to a particular image 208. Since the re-ranking model 220 may have been previously learned and/or trained, the re-ranking model 220 and/or the re-ranking module 126 may estimate the ranking scores for the set of re-ranked images 222. As illustrated in FIG. 4, a different set of images 302-310 may correspond to a different meta re-ranker 210-218. In some embodiments, different images 302-310 may be iteratively associated with each meta re-ranker 210-218 such that each meta re-ranker 210-218 may be associated with a different set of the images 302-310. For example, image 302 may correspond to meta-ranker 210, images 302 and 304 may correspond to meta re-ranker 212, images 302, 304, and 306 may correspond to meta re-ranker 214, and so on.

In various embodiments, the prototypes or the meta re-rankers 210-218 may be constructed utilizing a multiple-average prototype. More particularly, as opposed to considering a single image as a prototype, the prototypes or the meta re-rankers 210-218 may be constructed based on a prototype that considers multiple images, including a first image and one or more additional images from the neighboring rank positions. For example, when constructing meta-ranker 216, the prototype may consider images 302, 304, 306, 308, and 310.

As an alternate, or in addition, to the single-image prototype discussed above with respect to FIG. 3, the multiple-average prototype Pᵢ^{MA} may be constructed by selecting the top L images in the initial set of search results (e.g., images 302-310) and then cumulatively averaging the features (e.g., rank positions, relevancy, scores, etc.) of each ranked image beginning with the highest ranked position to the lowest ranked position i. In some embodiments, the prototype Pᵢ^{MA} may be defined by Equation 4, as set forth below:

$${P}_{i}^{MA} = \frac{1}{i} {\sum }_{j = 1}^{i} {I}_{j} . \qquad ( 4 )$$

Subsequently, the prototype(s) as identified in Equation 4 may be employed to compute the scores of individual meta re-rankers 210-218 by computing the similarity between a prototype and the image to be re-ranked, as set forth in Equation 5:

M^{MA}(Iⱼ|Pᵢ^{MA})=S(Iⱼ,Pᵢ^{MA}). (5)

Accordingly, with respect to re-ranking images 208 utilizing meta re-rankers 210-218 that are based at least in part on a multiple-average prototype, each rank position of the images 208 may be correlated with multiple images that includes the image associated with that rank position, and other images that are associated with neighboring rank positions. Further, since the prototype(s) may be based on an average of rank positions, instead of being based on a single image that is correlated to that rank position, any noise associated with images that may not be relevant to a particular query 206 may be smoothed out and/or eliminated.

In various embodiments, utilizing the multiple-average prototype approach, a corresponding meta re-ranker may be illustrated as Equation 6:

$${M}^{MA} ( {I}_{j} \vert {P}_{i}^{MA} ) = \frac{1}{i} {\sum }_{k = 1}^{i} S ( {I}_{k} , {I}_{j} ) . \qquad ( 6 )$$

Moreover, integrating Equation 6 into the re-ranking model 220 leads to the following expression, which is shown as Equations 7 and 8:

$$\begin{matrix}\begin{matrix}{R}^{MA} ( {I}_{j} ) = {\sum }_{i = 1}^{L} ( {w}_{i} \times \frac{1}{i} {\sum }_{k = 1}^{i} S ( {I}_{k} , {I}_{j} ) ) \\ = {\sum }_{i = 1}^{L} {α}_{i} \times S ( {I}_{i} , {I}_{j} ) ,\end{matrix} \\ where , & ( 7 ) \\ {α}_{i} = {\sum }_{k = i}^{L} \frac{{w}_{k}}{k} & ( 8 )\end{matrix}$$

In some embodiments, the re-ranking model 220 that is based on a multiple-average prototype may have at least three properties. First, the weights of images 208 that are ranked higher in the set of search results may be larger than the weights of images 208 that are ranked lower, as shown in Equation 9:

αᵢ>=αⱼ for i<j. (9)

The foregoing property may be derived from Equation 8, which states that the ranking in the set of search results may represent the ordering of the importance for each individual image 208 that is to be used as a prototype for the re-ranking. That is, re-ranking the set of search results based at least in part on a multiple-average prototype may rely more on the initial set of search results than if the re-ranking were based on the single-image prototype. The reason being that basing the re-ranking on the multiple-average prototype may deemphasize the influence of images 208 that are less relevant to the initial query 206. For example, the single-image prototype may relate to an image 208 that has a relatively low relevance to the initial query 206. On the other hand, even if an image 208 having a relatively low relevance is considered using the multiple-average prototype, considering other images that are associated with neighboring rank positions and that have relatively higher relevance to the query 206 may compensate for the lack of relevance of that particular image 208.

With respect to the second and third properties, the model weights W may be defined as shown in Equation 10:

wᵢ=i×Σₖ₌ᵢ^{L}(−1)^{k-i}αᵢ. (10)

Then, Equation 10 may be integrated into Equation to obtain Equation 11, as follows:

$$min \frac{1}{2} {\sum }_{i}^{ } {\vert i \times {\sum }_{k = i}^{L} {( - 1 )}^{k} {α}_{i} \vert}^{2} + C {\sum }_{ }^{ } {ξ}_{jk}^{i} \\ s . t . \\ ∀ {q}_{i} , {I}_{j} ≻ {I}_{k} \text{:} {A}^{T} ( M ( {I}_{j} ) - M ( {I}_{k} ) ) \geq 1 - {ξ}_{jk}^{i} \\ ∀ i , j , k \text{:} {ξ}_{jk}^{i} \geq 0. \qquad ( 11 )$$

As shown above, the regularization of each model parameter αᵢ may be weighted by its corresponding rank. Therefore, regarding multiple-average prototype generation, different α parameters may have different flexibility to determine the optimum value. Moreover, the parameters that correspond to higher ranks (e.g., smaller i) may have a larger solution space, and vice versa. In some embodiments, the higher an image 208 is ranked in the initial set of search results, the more important that image 208 may be for re-ranking the set of search results. Additionally, the re-ranking model set forth in Equation 11 not only may regularize the solution space of model parameters α, but may also perform various types of regularization such that images at adjacent ranks may have similar weights. As a result, and in view of the properties described above, the learned weights for individual images 208 utilizing the multiple-average prototype may decline gradually with the decreasing ranks.

In other embodiments, in addition to the single-image prototype and the multiple-average prototype, a multiple-set prototype may be utilized to construct the meta re-rankers 210-218. In these embodiments, the multiple-set prototype Pᵢ^{MS} at rank i may be defined as multiple images 208 ranked from a topmost position (e.g., the most relevant image 208 with respect to the query 206) to the rank i, as shown in Equation 12:

Pᵢ^{MS}={Iⱼ}ⱼ₌₁ⁱ. (12)

Moreover, given the multiple-set prototype Pᵢ^{MS}, a visual classifier may be learned by regarding each of the images 208 in Pᵢ^{MS} as positive samples, which may then be employed as a meta re-ranker 210-218, and the prediction score may be used as the meta re-ranking score. For the purposes of this discussion, positive samples may refer to images 208 that have a corresponding relevance to a particular query 206 that exceeds a predetermined threshold. Additionally, negative samples may also be utilized and selected in various manners. More particularly, background images and/or random images may be selected as negative samples. Background samples may be selected as negative samples since they may be less likely to be relevant to any query 206 associated with the user 102. In some embodiments, the images 208 included in the set of search results that are less relevant, and are therefore ranked closer to the bottom for each query 206, may be selected. In other embodiments, randomly sampled images 208 from a database may be selected as negative samples. Random samples may be selected as negative samples so that multiple sets of negative samples may be constructed, which may de-correlate different meta re-rankers 210-218.

Regardless of whether positive and/or negative samples are utilized, the meta re-ranker 210-218 with a multiple-set prototype may be defined in Equation 13:

M^{MS}(Iⱼ|Pᵢ^{MS})=p(Iⱼ|\hat{θ}), (13)

where \hat{θ} may represent the learned re-ranking model 220 and,

\hat{θ}=argmax_{θ}p(Pᵢ^{MS}|θ). (14)

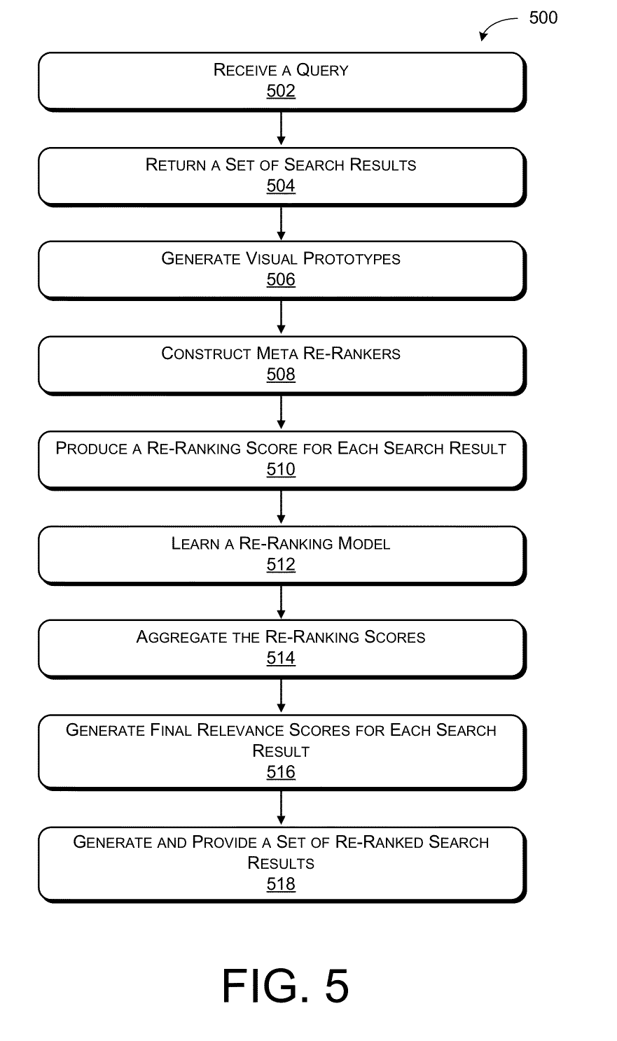

FIG. 5 illustrates various example processes for re-ranking a set of search results based at least in part on a re-ranking model. The example processes are described in the context of the systems of FIGS. 1-4, but are not limited to those environments. The order in which the operations are described in each example process is not intended to be construed as a limitation, and any number of the described blocks can be combined in any order and/or in parallel to implement each process. Moreover, the blocks in FIG. 5 may be operations that can be implemented in hardware, software, and a combination thereof. In the context of software, the blocks represent computer-executable instructions that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 5 is a flowchart illustrating a process 500 for re-ranking a set of search results based at least in part on a one or more queries and/or a re-ranking model. In various embodiments, the operations illustrated in FIG. 5 may be performed by a computing device, such as computing device 104, a server, such as content server 108, and/or any other device.

In particular, block 502 illustrates receiving a query. More particularly, a user (e.g., user 102) may utilize a computing device (e.g., computing device 104) to submit one or more queries that request various types of information (e.g., media content, textual data, images, etc.). The content server may then analyze the one or more queries to determine the specific information that is being requested.

Block 504 illustrates returning a set of search results. In some embodiments, upon receiving the one or more queries, the content server (e.g., search module 120 of content server 108) may conduct a search in an attempt to identify information that is relevant and/or responsive to the one or more queries. The search may be performed in association with a search engine and the information may include various types of data, media content (e.g., audio content, video content, etc.), images, and/or any other types of information. The content server may then generate a set of search results that includes search results that are determined to be relevant and/or responsive to the one or more queries. In various embodiments, the search results may be ranked and/or may be associated with a different rank position within the set of search results. For example, the search results may be ranked in a hierarchical order by which search results that are determined to be more relevant to the one or more queries are ranked higher.

Block 506 illustrates generating visual prototypes. In some embodiments, one or more prototypes may be generated that may represent at least one of the queries and/or the search results included in the set of search results. Moreover, the visual prototypes may be utilized to construct one or more meta re-rankers.

Block 508 illustrates constructing meta re-rankers. More particularly, the one or more prototypes may be used to construct one or more meta re-rankers. The meta re-rankers may be constructed in multiple manners, such as by utilizing the single-image prototype, the multiple-average prototype, and/or the multiple-set prototype, as discussed above with respect to FIGS. 1-4. In example embodiments, the meta re-rankers may be constructed by associating and/or correlating a different one of the search results with each meta re-ranker. Alternatively, or in addition, search results within the set of search results may be iteratively added and/or associated with each meta re-ranker in a descending order. For example, the systems described herein may associated a first top-ranked search result with a first meta re-ranker, associate the first image and a second lower-ranked search result with a second meta re-ranker, associate the first and second search results and a third lower-ranked search result with a third meta re-ranker, and so on. Furthermore, a set of positive or negative training samples may be utilized to construct the meta re-rankers.

Block 510 illustrates producing a re-ranking score for each search result. In particular, each of the meta re-rankers may produce a re-ranking score and/or a dimensional score vector for each search result included in the set of search results. In some embodiments, the re-ranking scores and/or the dimensional score vectors may correspond to a relative relevance to the one or more queries.

Block 512 illustrates learning a re-ranking model. In various embodiments, a re-ranking model may be learned in different manners and may then be relied upon to re-rank the search results that are included in the set of search results. For example, the re-ranking model may be learned by assigning varying weights to each rank position within the set of search results. The re-ranking model may also assign varying weights to different ones of the meta re-rankers. Moreover, since the re-ranking model may be learned based on a rank position within the set of search results, as opposed to the search results themselves, the re-ranking model may be query-independent. Therefore, the re-ranking model may be generalized and may be applied to multiple, different queries.

In other embodiments, the re-ranking model may be learned in an unsupervised manner by which the relevance of various search results may be automatically determined. This may be based at least in part on the rank position that is associated with each of the search results. Furthermore, the re-ranking model may also be learned in a supervised manner. For instance, the search results included in the set of search results may be manually labeled based at least in part on the determined relevance of the search results with respect to the one or more queries.

Block 514 illustrates aggregating the re-ranking scores. More particularly, the re-ranking scores and/or the dimensional score vectors computed by the meta re-rankers may be aggregated or combined. In some embodiments, the meta re-rankers may generate re-ranking scores and/or dimensional score vectors for one search result, multiple search results, or all of the search results included in the set of search results. Regardless, the re-ranking scores and/or the dimensional score vectors associated with the search results may be aggregated once they are generated.

Block 516 illustrates generating final relevance scores for each search result. More particularly, once the re-ranking scores and/or the dimensional score vectors have been aggregated, a final relevance score may be generated for each of the search results. In some embodiments, the final relevance score may represent, and/or may be used to define, a ranking position for each search result in a set of re-ranked search results. Furthermore, the search results may be re-ordered based at least in part on their respective relevance scores. For example, search results having higher relevance scores may be ranked higher than search results having lower relevance scores. However, the search results may be re-ranked in any manner and/or order.

Block 518 illustrates generating and providing a set of re-ranked search results. In further embodiments, based at least in part on the relevance scores of the search results, a set of re-ranked search results may be generated. The re-ranked search results may represent varying degrees of relevance and/or responsiveness of the search results to the previously submitted one or more queries. Once the set of re-ranked search results has been created, it may be provided to the user or computing device that was the source of the one or more queries. As a result, the user may access a set of search results that are believed to be relevant to the one or more queries and/or may be of interest to the user.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method comprising:
under control of one or more processors of a computing device:
receiving one or more queries;
in response to receiving the one or more queries, generating a set of search results by which each search result within the set of search results is ranked based on a relative relevance to the one or more queries;
assigning varying weights to each rank position within the set of search results;
learning a re-ranking model based at least in part on the assigned weights; and
re-ranking the search results, based at least in part on the re-ranking model, to generate a set of re-ranked search results.

2. The method as recited in claim 1, wherein the re-ranking model is query independent, enabling the re-ranking model to be generalized across multiple queries.

3. The method as recited in claim 1, further comprising:
generating one or more prototypes that visually represent at least one of the one or more queries or at least one search result included in the set of search results; and
outputting the set of re-ranked search results to a user that submitted the one or more queries.

4. The method as recited in claim 3, further comprising utilizing the one or more prototypes to construct at least one meta re-ranker, each meta re-ranker producing a re-ranking score for one or more of the search results included in the set of search results.

5. The method as recited in claim 4, wherein at least one of the one or more prototypes is constructed using a single-image process by correlating a single search result with each meta re-ranker.

6. The method as recited in claim 4, wherein at least one of the one or more prototypes is constructed using a multiple-average process by iteratively adding search results within the ranked set of search results to each meta re-ranker in a descending order.

7. The method as recited in claim 4, wherein at least one of the one or more prototypes is constructed using a multiple-set process by iteratively adding search results within the ranked set of search results to each meta re-ranker in a descending order, each meta re-ranker being constructed by learning a classifier from the at least one prototype and selected negative samples.

8. The method as recited in claim 4, further comprising aggregating the re-ranking scores produced by each of the meta re-rankers to generate a final relevance score for each of the search results, the final relevance score being used to define a rank position for each search result within the set of re-ranked search results.

9. The method as recited in claim 1, wherein the re-ranking model is learned based at least in part on automatically selecting at least a subset of the search results that are determined to be most relevant to the one or more queries or by referring to labels that were manually applied to at least a subset of the search results with varying degrees of relevance to the one or more queries.

10. One or more computer-readable media having computer-executable instructions that, when executed by one or more processors, configure the one or more processors to perform operations comprising:
returning a set of images in response to one or more queries, each image being ranked with respect to one another;
generating one or more prototypes that visually represent the one or more queries and that are used to construct one or more meta re-rankers; and
re-ranking the images to generate a set of re-ranked images based at least in part on re-ranking scores provided by the one or more meta re-rankers.

11. The one or more computer-readable media as recited in claim 9, wherein:
a relevance probability of each image with respect to the one or more queries represents a corresponding rank position in the set of images; and
the one or more meta re-rankers are applications, models, or schemas that generate re-ranking scores for each of the images, the re-ranking scores being aggregated to produce a final relevance score for each of the images.

12. The one or more computer-readable media as recited in claim 11, wherein the final relevance score of each image defines a rank position in the set of re-ranked images.

13. The one or more computer-readable media as recited in claim 10, wherein the set of re-ranked images is generated based at least in part on a re-ranking model that is learned from a manually labeled subset of the images based at least in part on a respective relevance to the one or more queries and rank positions of the subset of images.

14. The one or more computer-readable media as recited in claim 10, wherein the one or more meta re-rankers are constructed by associating a different one of the images with the one or more prototypes.

15. The one or more computer-readable media as recited in claim 10, wherein the one or more prototypes are constructed by iteratively associating the images with the one or more meta re-rankers in a descending order such that a first image is associated with a first meta re-ranker and the first image and a second image are associated with a second meta re-ranker.

16. A method comprising:
under control of one or more processors of a computing device:
receiving one or more queries that each request one or more images;
generating a set of images that include images that are responsive to the one or more queries, each image of the set of images being associated with a rank position based at least in part on a relative relevance of the images;
utilizing one or more prototypes that visually represent the one or more queries to construct one or more meta re-rankers, the one or more meta re-rankers producing a re-ranking score for each of the images;
aggregating the re-ranking scores associated with the images to produce a final relevance score for each image; and
generating a set of re-ranked images based at least in part on the re-ranking model and the final relevance scores for the images.

17. The method as recited in claim 16, further comprising learning the re-ranking model based at least in part on the rank position of at least a subset of the queries included in the set of images.

18. The method as recited in claim 16, wherein the re-ranking model assigns varying weights to different ones of the one or more meta re-rankers.

19. The method as recited in claim 16, further comprising learning the re-ranking model in an unsupervised manner by which relevant information is automatically determined from the images included in the set of images.

20. The method as recited in claim 16, further comprising learning the re-ranking model in a supervised manner by which the images included in the set of images have been manually labeled based at least in part on a determined relevance of the images with respect to the one or more queries.
